(19) United States
(12) Patent Application Publication
(10) Pub. No.: US 2006/0108783 A1
(43) Pub. Date: May 25, 2006

(54) Structural assembly for vehicles and method of making same

(76) Inventors: Chi-Mou Ni, Washington, MI (US); Monir Zaman, Rochester Hills, MI (US); Gary D. Leinonen, Rochester Hills, MI (US); Gerald A. Nyquist, Fenton, MI (US); Charles J. Bruggemann, Rochester Hills, MI (US)

Correspondence Address: LAURA C. HARGITT;General Motors Corporation, Legal Staff, Mail Code 482-C23-B21, P.O. Box 300, Detroit, MI, 48265-3000, US

(21) Appl. No.: 10/997,476

(22) Filed: Nov. 24, 2004

(51) Int. Cl. B60G 1/00; B62D 21/00; B21D 53/88

(52) U.S. Cl. 280/781; 280/124.1; 29/897.2

(57) ABSTRACT

A structural assembly and method of making same for a vehicle includes a hydroformed tubular member and at least one external reinforcement disposed about and secured to at least a portion of the tubular member.

### TECHNICAL FIELD

The present invention relates generally to vehicles and, more specifically, to a structural assembly for a vehicle.

### BACKGROUND OF THE INVENTION

It is known to construct vehicles such as automotive vehicles using hydroformed members for vehicle body and chassis structure applications. In some automotive vehicle applications, hydroformed members may require additional metal pieces as external reinforcements to satisfy their structural performance requirements, as normally done in stamped parts. For example, a suspension cross member assembly may include a hydroformed member and two external reinforcements. The conventional manufacturing process for this suspension cross member assembly consists of separate processes and toolings for hydroforming of the member, stamping of the reinforcements, and the final assembly.

As a result, it is desirable to obtain a structural assembly for a vehicle from a single hydroformed die. It is also desirable to provide a method to consolidate hydroforming and reinforcing for a structural assembly of a vehicle in a single step process. It is further desirable to provide a method of making a structural assembly for a vehicle that reduces the number of forming and assembly steps and is less time consuming and costly. Therefore, there is a need in the art to provide a structural assembly for a vehicle and method of making same that meets these desires.

### SUMMARY OF THE INVENTION

It is, therefore, one object of the present invention to provide a new structural assembly for a vehicle that has a single step process.

It is another object of the present invention to provide a new method of making a structural assembly for a vehicle that has a single step process.

To achieve the foregoing objects, the present invention is a structural assembly for a vehicle including a hydroformed tubular member and at least one external reinforcement disposed about and secured to at least a portion of the tubular member.

Additionally, the present invention is a method of making a structural assembly for a vehicle. The method includes the steps of providing a tubular member and providing at least one external reinforcement. The method also includes the steps of disposing at least one external reinforcement over a surface of the tubular member and securing at least one reinforcement to the tubular member to form a pre-form structural assembly. The method further includes the steps of hydroforming the pre-form structural assembly and forming a finished structural assembly.

One advantage of the present invention is that a structural assembly and method of making same is provided for a vehicle that locally and externally reinforces a structural member. Another advantage of the present invention is that the method consolidates the hydroforming of the tube, stamping of the reinforcements, and the final assembly into a single step process. Yet another advantage of the present invention is that the method uses a co-forming process to obtain the final cross member assembly from a single hydroforming die. Still another advantage of the present invention is that the structural assembly incorporates an external local reinforcement that is simple and relatively inexpensive. A further advantage of the present invention is that the structural assembly and method reduce tooling costs. Yet a further advantage of the present invention is that the structural assembly and method improves part and assembly quality. Still a further advantage of the present invention is that the structural assembly and method reduces tooling and fixtures required using conventional processes. Another advantage of the present invention is that the method is a co-forming process that reduces the numbers of forming and assembly steps, thereby achieving significant tooling cost savings. Yet another advantage of the present invention is that the method greatly improves quality in parts and their final assembly due to the final hydroforming process using high fluid pressure to form the metal and tighten the fit-up of the assembly.

Other objects, features, and advantages of the present invention will be readily appreciated, as the same becomes better understood, after reading the subsequent description taken in conjunction with the accompanying drawings.

### BRIEF DESCRIPTION OF THE DRAWINGS

FIG. 1 is an exploded perspective view of a structural assembly, according to the present invention.

FIG. 2 is a perspective view of the structural assembly of FIG. 1 illustrated in a partial forming stage.

FIG. 3 is a perspective view of the structural assembly of FIG. 1 illustrated in a final forming stage.

FIG. 4 is a fragmentary elevational view of the structural assembly of FIG. 1 illustrated as a pre-form assembly.

FIG. 5 is a fragmentary elevational view of a pre-formed reinforcement for the pre-form assembly of FIG. 4.

FIG. 6 is a fragmentary elevational view of the structural assembly of FIG. 3 illustrated in a hydroforming die.

### DESCRIPTION OF THE PREFERRED EMBODIMENT

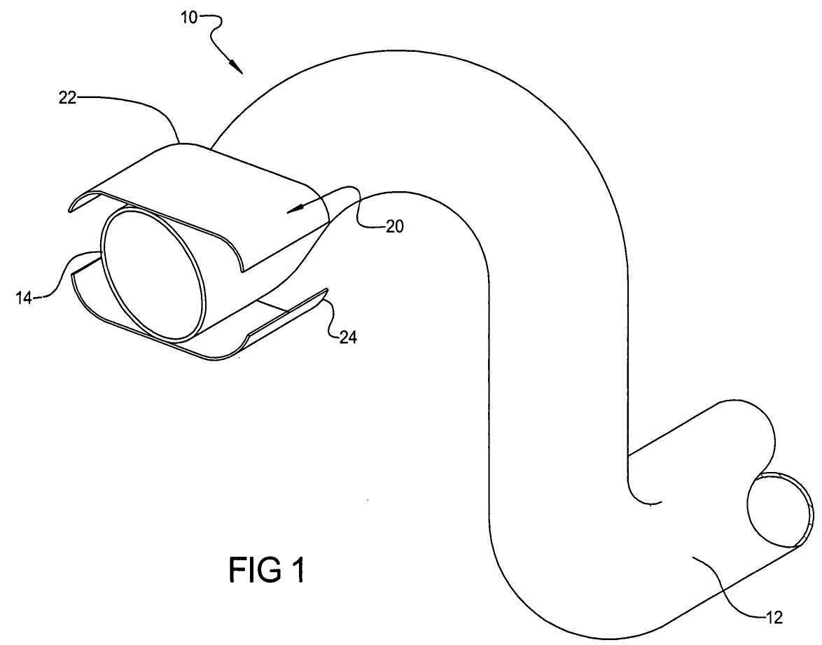

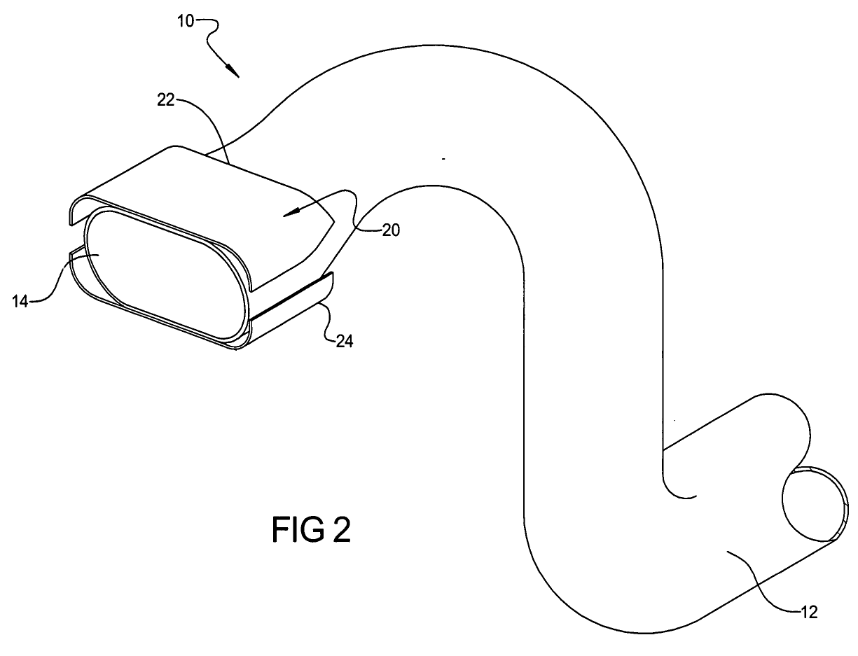

Referring to the drawings and in particular FIGS. 1 through 3, one embodiment of a structural assembly 10, according to the present invention, is shown for a vehicle (not shown). In the embodiment illustrated, the structural assembly 10 is a partial view of a suspension cross member assembly. It should be appreciated that the structural assembly 10 may be used for other applications in the vehicle.

Referring to FIGS. 1 through 3, the structural assembly 10 includes at least one tubular component or member 12. In one embodiment, the tubular member 12 has at least one side wall 14 forming a generally hollow cross-sectional shape. The tubular member 12 may include at least one aperture (not shown) extending through at least one of the side walls 14. The tubular member 12 may be straight or pre-bent. The tubular member 12 is made of a metal material and formed by a hydroforming process. The tubular member 12 is a monolithic structure being integral, unitary, and one-piece.

The structural assembly 10 also includes at least one or a plurality of external reinforcements, generally indicated at 20, disposed about the structural member, in this embodiment, the tubular member 12. The reinforcements 20 include an upper reinforcement 22 and a lower reinforcement 24. The upper reinforcement 22 extends axially and may cover the whole length or partial length of the tubular member 12. The upper reinforcement 22 may be initially flat or curved. The upper reinforcement 22 may include at least one aperture (not shown) extending therethrough. The lower reinforcement 24 extends axially and may cover the whole length or partial length of the tubular member 12. The lower reinforcement 24 may be initially flat or curved. The lower reinforcement 24 may include at least one aperture (not shown) extending therethrough. The reinforcements 22 and 24 are made of a metal material. Each reinforcement 22 and 24 may be straight, pre-bent, formed, or tack welded to fit the geometry of the tubular member 12. Each reinforcement 22 and 24 is a monolithic structure being integral, unitary, and one-piece.

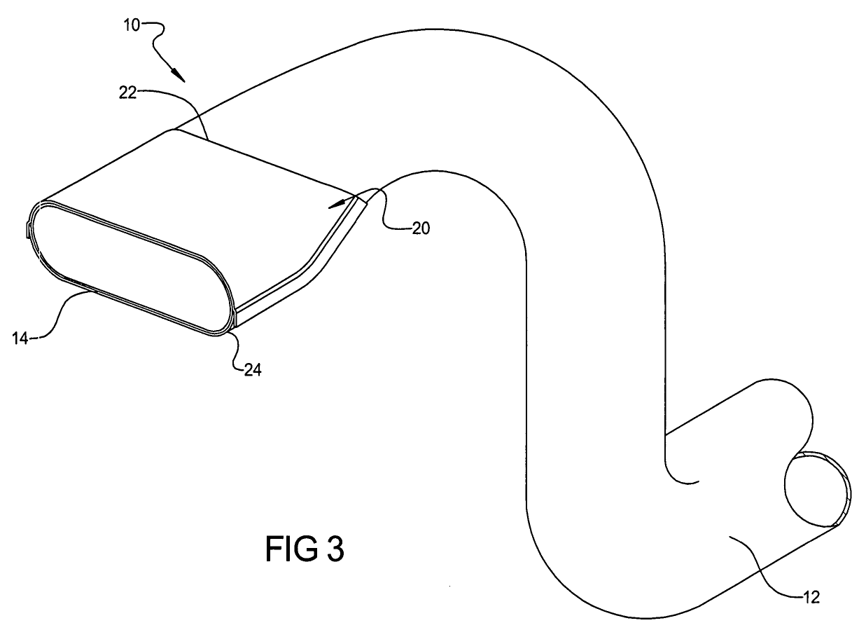

Referring to FIG. 3, the reinforcements 22 and 24 are disposed in abutting relationship with the side walls 14 of the tubular member 12. The reinforcements 22 and 24 are fixedly secured to the side walls 14 of the tubular member 12. More specifically, the reinforcements 22 and 24 are fixedly secured by an interference fit along an expanse thereof. It should be appreciated that the reinforcements 22 and 24 and tubular member 12 are integral and one-piece.

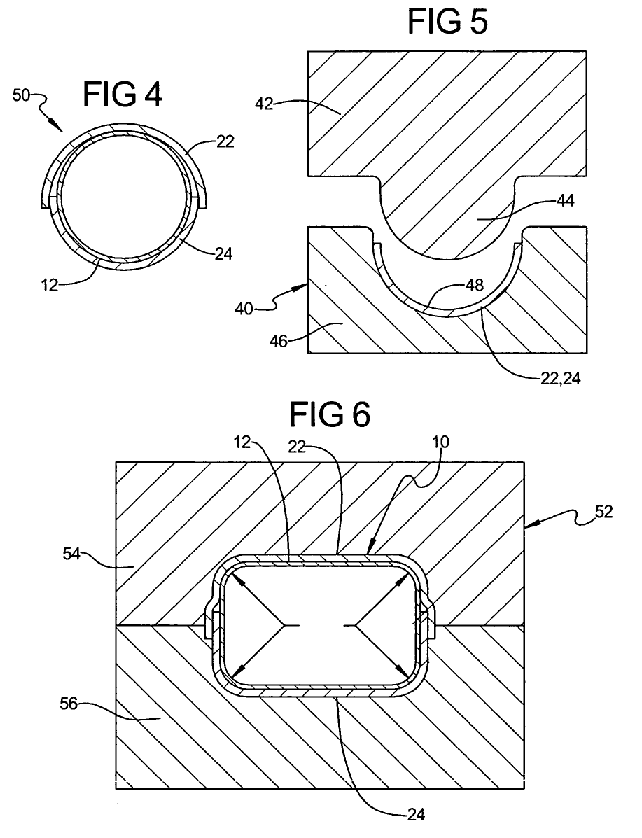

Referring to FIGS. 1 through 6, a method, according to the present invention, of making the structural assembly 10 is shown. The method includes the step of providing at least one tubular member 12. The tubular member 12 is made of a metal material. The tubular member 12 may be straight or pre-bent.

The method includes the step of providing at least one, preferably a plurality of the reinforcements 20. The method includes the step of forming the upper reinforcement 22 and the lower reinforcement 24. The reinforcements 22 and 24 are bent or formed to conform to the geometry of the tubular member 12. As illustrated in FIGS. 4 and 5, in one embodiment, the tubular member 12 has a generally circular cross-sectional shape. Each reinforcement 22 and 24 can be pre-formed or made from a simple die set 40. The die set 40 has an upper die half 42 with a projection 44. The die set 40 also has a lower die half 46 with a cavity 48. The projection 44 is disposed in the cavity 48 to form the reinforcements 22 and 24 when the die set 40 is closed. The reinforcements 22 and 24 are made of a metal material.

The method includes the step of securing the reinforcements 22 and 24 to the tubular member 12. The reinforcements 22 and 24 are secured to a surface of the tubular member 12 by at least one securement such as welding, preferably tack welding, to form a pre-form, generally indicated at 50.

According to one method of hydroforming, the pre-form 50, which includes the tubular member 12 with the attached reinforcements 22 and 24, is placed in a hydroforming die set, generally indicated at 52, comprised of an upper die half 54 and a lower die half 56 for a final forming operation. The ends of the tubular member 12 of the pre-form 50 are sealed and hydraulic fluid is pumped into the tubular member 12 under pressure. The upper die half 54 and lower die half 56 are progressively closed so that the pre-form 50 is progressively deformed and the pressurized fluid captured therein expands the walls of the tubular member 12 and reinforcements 22,24 into cavity portions of the die halves 54,56.

Once the die is closed, the tubular member 12 and reinforcements 22, 24 are then expanded to a final cross-sectional profile by increasing the hydraulic pressure sufficient to exceed the yield limit of the tubular member 12 so that the tubular member 12 and reinforcements 22,24 are forced into conformity with the cavity portions of the die halves 54,56. The die halves 54,56 are then opened to permit removal of the finished structural assembly 10 from the die halves. It should be appreciated that other methods of hydroforming may involve substitution of pre-forming for the initial pressure stage.

The present invention has been described in an illustrative manner. It is to be understood that the terminology, which has been used, is intended to be in the nature of words of description rather than of limitation.

Many modifications and variations of the present invention are possible in light of the above teachings. Therefore, within the scope of the appended claims, the present invention may be practiced other than as specifically described.

1. A structural assembly for a vehicle comprising:
a hydroformed tubular member; and
at least one external reinforcement disposed about and secured to at least a portion of said tubular member.

2. A structural assembly as set forth in claim 1 wherein said at least one external reinforcement is formed to conform to a geometry of said tubular member.

3. A structural assembly as set forth in claim 1 wherein said at least one external reinforcement is made of a metal material.

4. A structural assembly as set forth in claim 1 wherein said tubular member and said at least one external reinforcement are integral and one-piece.

5. A structural assembly as set forth in claim 1 wherein said tubular member and said at least one external reinforcement are expanded during hydroforming.

6. A structural assembly as set forth in claim 1 wherein said at least one external reinforcement comprises an upper reinforcement being disposed on an upper surface of said tubular member and a lower reinforcement being disposed on a lower surface of said tubular member.

7. A structural assembly as set forth in claim 1 wherein said at least one external reinforcement and said tubular member are joined into a pre-form for hydroforming.

8. A structural assembly as set forth in claim 1 wherein said tubular member has a generally rectangular cross-sectional shape.

9. A structural assembly as set forth in claim 1 wherein said tubular member is made of a metal material.

10. A structural assembly for a vehicle comprising:
a hydroformed tubular member;
an upper reinforcement being disposed on an upper surface of said tubular member and a lower reinforcement being disposed on a lower surface of said tubular member; and
wherein said tubular member and said upper reinforcement and said lower reinforcement are expanded during hydroforming and are integral and one-piece.

11. A method of making a structural assembly for a vehicle, said method comprising the steps of:
providing a tubular member;
providing at least one external reinforcement;
disposing the at least one external reinforcement over a surface of the tubular member;
securing the at least one external reinforcement to the tubular member to form a pre-form structural assembly; and
hydroforming the pre-form structural assembly and forming a finished structural assembly.

12. A method as set forth in claim 11 including the step of forming the at least one external reinforcement to conform to a geometry of the tubular member.

13. A method as set forth in claim 11 wherein said step of providing at least one external reinforcement comprises providing an upper reinforcement and a lower reinforcement.

14. A method as set forth in claim 11 wherein said step of disposing comprises disposing the upper reinforcement on an upper surface of the tubular member and disposing the lower reinforcement on a lower surface of the tubular member.

15. A method as set forth in claim 11 wherein said step of hydroforming comprises hydroforming the tubular member, upper reinforcement and lower reinforcement together to form the finished structural assembly.

16. A method of making a structural assembly for a vehicle, said method comprising the steps of:
providing a tubular member;
forming at least one external reinforcement to conform to a geometry of the tubular member;
disposing the at least one external reinforcement on a surface of the tubular member;
securing the at least one external reinforcement to the tubular member by welding the at least one external reinforcement to a surface of the tubular member; and
hydroforming the at least one external reinforcement and the tubular member together to form a structural assembly.
